(19) United States
(12) Patent Application Publication
(10) Pub. No.: US 2002/0109652 A1
(43) Pub. Date: Aug. 15, 2002

(54) Liquid crystal display panel and driving method thereof

(76) Inventors: Ji Chul Lim, Pusan-shi (KR); Joun Ho Lee, Taegu-shi (KR)

Correspondence Address: LONG ALDRIDGE & NORMAN, LLP, 701 PENNSYLVANIA AVENUE N.W., SUITE 600, WASHINGTON, DC, 20004, US

(21) Appl. No.: 09/892,882

(22) Filed: Jun. 28, 2001

(30) Foreign Application Priority Data
Dec. 23, 2000 (KR) P2000-81418

(51) Int. Cl. G09G 3/36

(52) U.S. Cl. 345/87

(57) ABSTRACT

A liquid crystal display panel and a driving method thereof which are capable of equalizing a brightness of each liquid crystal cell. In the panel, the dummy data line is provided at a black matrix area of the outermost liquid crystal cell of the liquid crystal display panel. Accordingly, a brightening phenomenon of the liquid crystal cell connected to the last data line can be prevented.

### CROSS REFERENCES TO RELATED APPLICATIONS

This application claims benefit of Korean Patent Application No. P00-81418, filed on Dec. 23, 2000, the entirety of which is hereby incorporated by reference for all purposes as if fully set forth herein.

### BACKGROUND OF THE INVENTION

1. Field of the Invention

This invention relates to a liquid crystal display, and more particularly to a liquid crystal display panel and a driving method thereof that are capable of equalizing a brightness of each liquid crystal cell.

2. Description of the Prior Art

Generally, a liquid crystal display controls the light transmissivity of liquid crystal cells in a liquid crystal display panel to display a picture corresponding to a video signal. Such a liquid crystal display uses a line-inversion system, a column-inversion system, a dot-inversion system, or a group-inversion system, etc. so as to drive the liquid crystal cells in the liquid crystal display panel.

In a method of driving a liquid crystal display panel using line-inversion, as shown in FIG. 1A and FIG. 1B, the polarities of data signals applied to the liquid crystal display panel are inverted in accordance with row lines, that is, gate lines on the liquid crystal display panel, and in accordance with frames.

In a method of driving a liquid crystal display panel using column-inversion, as shown in FIG. 2A and FIG. 2B, the polarities of data signals applied to the liquid crystal display panel are inverted in accordance with column lines, that is, source lines on the liquid crystal display panel, and in accordance with frames.

In a method of driving a liquid crystal display panel using dot-inversion, as shown in FIG. 3A and FIG. 3B, data signals having polarities contrary to the adjacent liquid crystal cells on the gate lines and to the adjacent liquid crystal cells on the data lines are applied to each liquid crystal cell in the liquid crystal display panel, and the polarities of data signals applied to all liquid crystal cells in the liquid crystal display panel are inverted every frame. In other words, in the dot-inversion system, when a video signal in the odd-numbered frame is displayed, data signals are applied to the liquid crystal cells in the liquid crystal display panel in such a manner that the positive (+) polarity and the negative (−) polarity appear alternately as shown in FIG. 3A as one goes from the liquid crystal cell at the upper left end to the liquid crystal cells at the right side, and to the liquid crystal cells at the bottom. On the other hand, when a video signal in an even-numbered frame is displayed, data signals applied to the liquid crystal cells have the polarities inverted contrary to those in the odd-numbered frame, as shown in FIG. 3B.

The line-inversion system in the above-mentioned liquid crystal display panel driving method has a serious crosstalk in the horizontal direction. Particularly, when a picture with two alternating colors (i.e., a color with a medium gray scale and a black color), depending on the line, is displayed on a liquid crystal display panel using line inversion, a serious flicker emerges between the horizontal lines. Similarly, when a picture with two alternating colors (i.e., a color with a medium gray scale and a black color), depending on the line, is displayed on a liquid crystal display panel using column inversion, a serious crosstalk in the vertical direction is generated. The dot-inversion system in which the polarities of the data signals are inverted in both the vertical and horizontal directions, unlike the line-inversion system and the column inversion system, provides better picture quality than the line- and column-inversion systems. Recently, owing to such an advantage, the liquid crystal display panel driving method of dot-inversion has been widely used.

Referring to FIG. 4, a conventional liquid crystal display panel 4 driven in a dot inversion system includes first pixel electrodes 2 connected to a gate line GL and first to (n−1)th data lines DL1, DL2, . . . , DL(n−1), and a second pixel electrode 12 connected to the gate line GL and the nth data line DLn.

The first pixel electrodes 2 are connected to thin film transistors (TFT's) serving as switching devices arranged at each intersection between the gate line GL and the first to (n−1)th data lines DL1, DL2, . . . , DL(n−1). Each of the first pixel electrodes 2 drives a liquid crystal cell, along with a common electrode (not shown), in accordance with a data signal applied via the TFT. The adjacent liquid crystal cells are supplied with data signals having polarities opposite to each other to display a picture.

The second pixel electrode 12 is connected to a TFT positioned at an intersection between the gate line GL and the nth data line DL. The second pixel electrode 12 drives a liquid crystal cell, along with a common electrode, in accordance with a data signal applied via the TFT. The liquid crystal cell is supplied with a data signal having the polarity contrary to the (n−1)th data line, DL(n−1), via the nth data line, DLn, to display a picture.

Such a liquid crystal cell in the liquid crystal display panel 4 is influenced by a data line signal adjacent to the pixel electrode. In other words, voltages of the first pixel electrodes 2 are varied by first and second capacitors Cn and Cn+1 that are parasitic capacitances positioned between the adjacent data lines, as shown in FIG. 5. The voltages of the first pixel electrodes 2 are varied by a coupling with the adjacent data lines being adjacent to the first pixel electrodes 2 as indicated by the following equation:

V_{pixel 1}=Vₚᵢₓₑₗ−(Cₙ/Cₜₒₜₐₗ)*V_{data(n)}+(Cₙ₊₁/Cₜₒₜₐₗ)*V_{data(n+1)} (1)

However, the first pixel electrode 2 is coupled by the first and second capacitors Cn and Cn+1 while the second pixel electrode 12 positioned at the right side of the panel is coupled only by the first capacitor Cn. In other words, a voltage of the second pixel electrode 12 is changed only by the nth data line signal. The voltage of the second pixel electrode 12 is varied by a coupling with the nth data line DLn being adjacent to the second pixel electrode 12 as indicated by the following equation:

V_{pixel 2}=Vₚᵢₓₑₗ−(Cₙ/Cₜₒₜₐₗ)*V_{data(n)} (2)

Accordingly, a difference of Cₙ₊₁×V_{Data(n+1)}/Cₜₒₜₐₗ exists between the general pixel electrodes (e.g., the first pixel electrode 2) and the second pixel electrode 12 positioned at the right side of the liquid crystal display panel 4. This difference forces a small effective voltage to be applied to a blue (B) pixel connected to the last data line DLn. Therefore, when the LCD is in a normally white mode, it has a problem in that a blue (B) pixel connected only to the last data line DL appears more bright than the periphery thereof to thereby generate a color signal difference and a brightness difference.

### SUMMARY OF THE INVENTION

Accordingly, it is an object of the present invention to provide a liquid crystal display panel and a driving method thereof that are capable of equalizing a brightness of each liquid crystal cell.

In order to achieve these and other objects of the invention, a liquid crystal display panel according to one aspect of the present invention includes a plurality of data lines included in a display area; a plurality of gate lines crossing the data lines; a dummy data line included in a non-display area other than the display area and formed in parallel to the data lines; a switching device positioned at each intersection between the data lines and the gate lines; and a pixel electrode driven by a switching of the switching device.

In the liquid crystal display panel, the dummy data line is supplied with a signal having an inverted phase with respect to a data on the data line being adjacent to the dummy data line.

The liquid crystal display panel further includes a dummy switching device positioned at each intersection between the dummy data line and the gate lines; and a dummy pixel electrode connected to the dummy switching device. In the liquid crystal display panel, each of the dummy data line and the dummy pixel electrode further includes a black matrix for shutting off a light.

The liquid crystal display panel further includes dummy voltage supply means for supplying the signal to the dummy data line. The dummy voltage supply means includes an inverter for making a phase inversion of a signal on the data line being adjacent to the dummy data line. The dummy voltage supply means includes a shorting bar for electrically connecting the data line supplied with a voltage having the same phase as a voltage applied to the dummy data line to the dummy data line. The dummy voltage supply means includes a dummy voltage generator for directly applying a voltage to the dummy data line.

A liquid crystal display panel according to another aspect of the present invention includes a plurality of data lines included in a display area; a plurality of gate lines crossing the data lines; a switching device positioned at each intersection between the data lines and the gate lines; a pixel electrode supplied with a voltage on the data line by a switching of the switching device; and a dummy data line for compensating a capacitance value difference of an the adjacent pixel electrode thereto.

In the liquid crystal display panel, the dummy data line is supplied with a signal having an inverted phase with respect to a data on the data line being adjacent to the dummy data line.

The liquid crystal display panel further includes a dummy switching device positioned at each intersection between the dummy data line and the gate lines; and a dummy pixel electrode connected to the dummy switching device.

In the liquid crystal display panel, each of the dummy data line and the dummy pixel electrode further includes a black matrix for shutting off a light.

The liquid crystal display panel further includes dummy voltage supply means for supplying the signal to the dummy data line. The dummy voltage supply means includes an inverter for making a phase inversion of a signal on the data line being adjacent to the dummy data line. The dummy voltage supply means includes a shorting line for electrically connecting the data line supplied with a voltage having the same phase as a voltage applied to the dummy data line to the dummy data line. The dummy voltage supply means includes a dummy voltage generator for directly applying a voltage to the dummy data line.

A method of driving a liquid crystal display panel according to still another aspect of the present invention includes the steps of supplying video signals to pixel electrodes in a display area; and supplying a signal to the dummy data line in a non-display area for compensating a capacitance value difference of adjacent pixel electrodes thereto.

In the driving method, the dummy data line is supplied with a signal having an inverted phase with respect to a data on the data line being adjacent to the dummy data line.

### BRIEF DESCRIPTION OF THE DRAWINGS

These and other objects of the invention will be apparent from the following detailed description of the embodiments of the present invention with reference to the accompanying drawings, in which:

FIG. 1A and FIG. 1B depict a line-inversion system;

FIG. 2A and FIG. 2B depict a column-inversion system;

FIG. 3A and FIG. 3B depict a dot-inversion system;

FIG. 4 is a schematic plan view of a liquid crystal display panel driven by a conventional dot-inversion system;

FIG. 5 is a view for explaining a coupling effect of the liquid crystal display panel shown in FIG. 1;

FIG. 6 is a schematic plan view of a liquid crystal display panel driven by a dot-inversion system according to an embodiment of the present invention;

FIG. 7 is a view for explaining a coupling effect of the liquid crystal display panel shown in FIG. 6;

FIG. 8 depicts a signal applied to a dummy data line of a liquid crystal display panel according to an embodiment of the present invention;

FIG. 9 depicts a signal applied to a dummy data line of a liquid crystal display panel according to another embodiment of the present invention; and

FIG. 10 depicts a signal applied to a dummy data line of a liquid crystal display panel according to still another embodiment of the present invention.

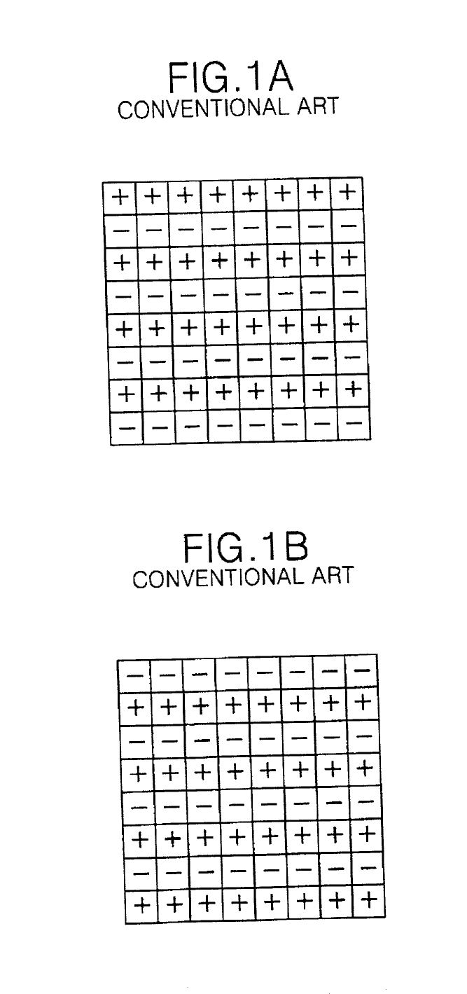

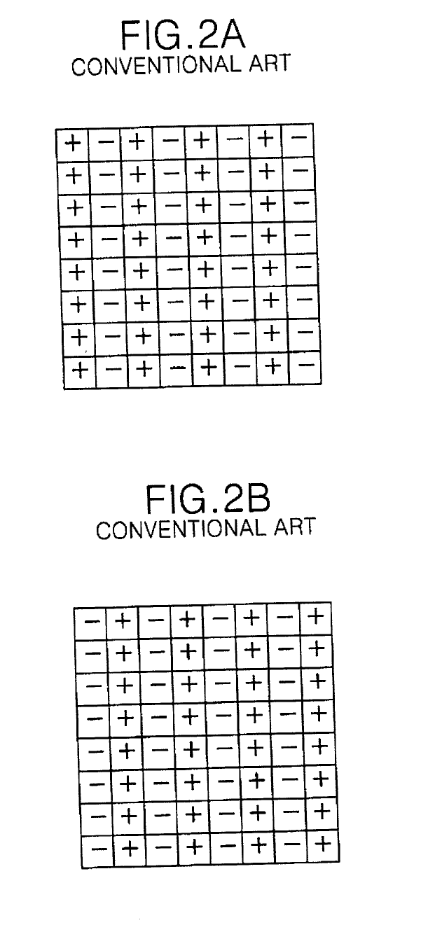

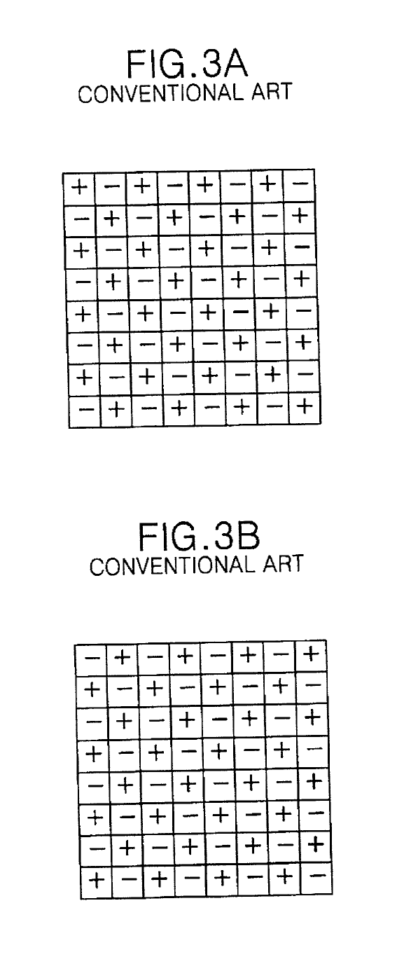

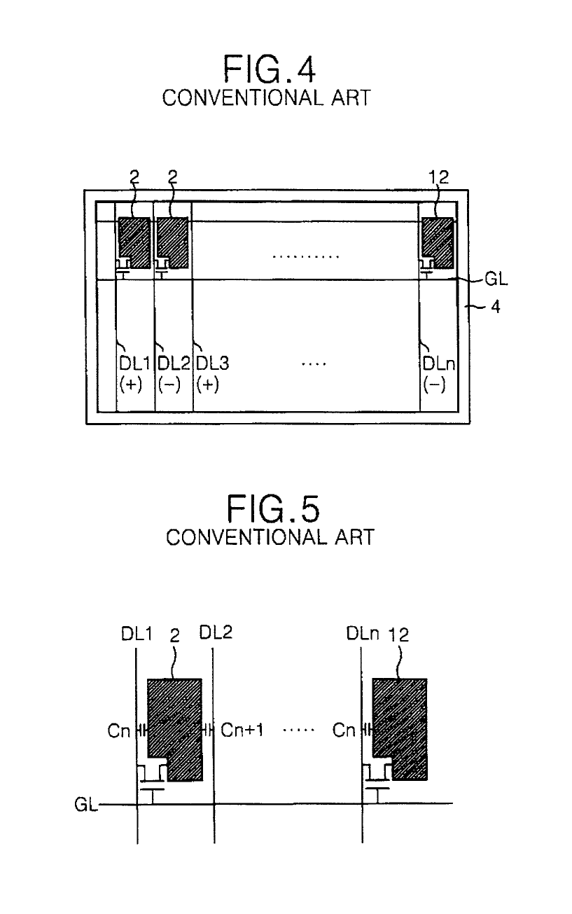

### DETAILED DESCRIPTION OF THE PREFERRED EMBODIMENTS

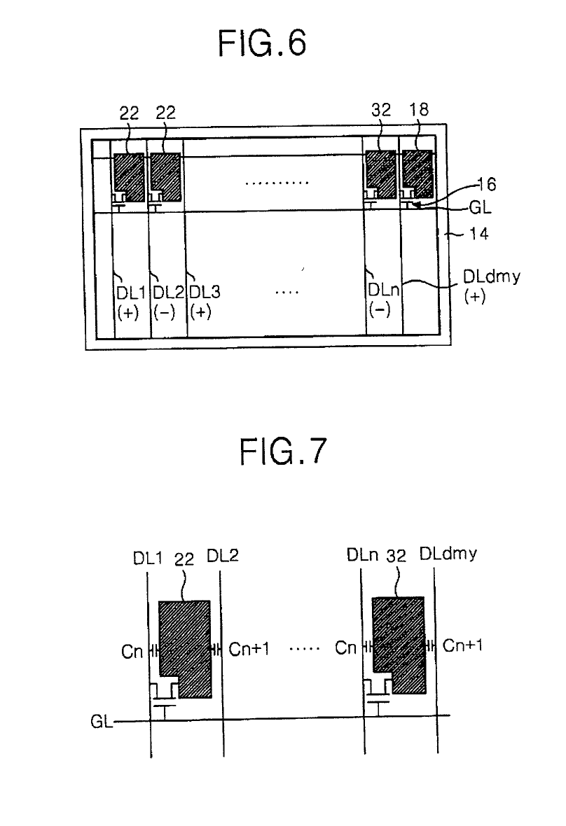

Referring to FIG. 6, there is shown a liquid crystal display panel driven by a dot-inversion system according to an embodiment of the present invention.

The liquid crystal display panel 14 includes first pixel electrodes 22 connected to a gate line, or scanning line, GL and also connected to first to (n−1)^{th} data lines DL1, DL2, . . . , DL(n−1), a second pixel electrode 32 connected to the gate line, or scanning line, GL and the nth data line DLn, a dummy data line DLdmy positioned at the right side of the second pixel electrode 32, and a dummy TFTs 16 and dummy pixel electrodes 18 connected to the dummy data line DLdmy.

The first pixel electrodes 22 are connected to thin film transistors (TFTs) serving as switching devices arranged at each intersection between the gate line GL and the first to (n−1)^{th} data lines DL1, DL2, . . . , DL(n−1). Each of the first pixel electrodes 22 drives a liquid crystal cell, along with a common electrode (not shown), in accordance with a data signal applied via the TFT. During each scanning period, the adjacent liquid crystal cells are supplied with data signals having the polarities opposite to each other to display a picture.

The second pixel electrode 32 is connected to a TFT positioned at an intersection between the gate line GL and the nth data line DL. The dummy data line DLdmy adjacent to the second pixel electrode 32 is supplies a signal having a phase inverted from a signal applied to the nth data line DLn is inputted. The dummy data line DLdmy is provided at a black matrix area (not shown) of the last data line DLn. The second pixel electrode 32 drives a liquid crystal cell, along with a common electrode, in accordance with a data signal applied via the TFT. Accordingly, the liquid crystal cell is arranged between the n^{th} data line DLn and the dummy data line DLdmy to apply signals having the contrary polarity to them, thereby displaying a picture. The dummy TFTs 16 and the dummy pixel electrodes 18 connected between the dummy data line Dldmy and the gate line GL allows the dummy data line Dldmy to have a capacitance (or an impedance) equal to the capacitance (or impedance) of other data line DL1, DL2, . . . , DLn. The dummy data line DLdmy, the dummy TFTs 16 and the dummy pixel electrodes 18 enable the second pixel electrode 32 to have the same coupling effect as the first pixel electrode 22.

Referring to FIG. 7, a voltage of the first pixel electrode 22 formed between the first data line DL1 and the second data line DL2 is varied by the first and second capacitors Cn and Cn+1. A voltage of the second pixel electrode 32 formed between the nth data line DLn and the dummy line DLdmy is varied by the first and second capacitors Cn and Cn+1. Since electric charges accumulated in the first and second pixels 22 and 32 become equal to each other, the second pixel electrode 32 positioned at the night side of the liquid crystal display panel 14 is coupled in similarity to the first pixel electrode 22. In other words, voltages charged in the first and second pixel electrodes 22 and 32 becomes equal to each other as indicated by the following equation:

$${V}_{pixel1} = {V}_{pixel} - ( {C}_{n} / {C}_{total} ) * {V}_{data ( n )} + ( {C}_{n + 1} / {C}_{total} ) * {V}_{data ( n + 1 )} \\ {V}_{pixel2} = {V}_{pixel} - ( {C}_{n} / {C}_{total} ) * {V}_{data ( n )} + ( {C}_{n + 1} / {C}_{total} ) * {V}_{data ( n + 1 )} \qquad ( 3 )$$

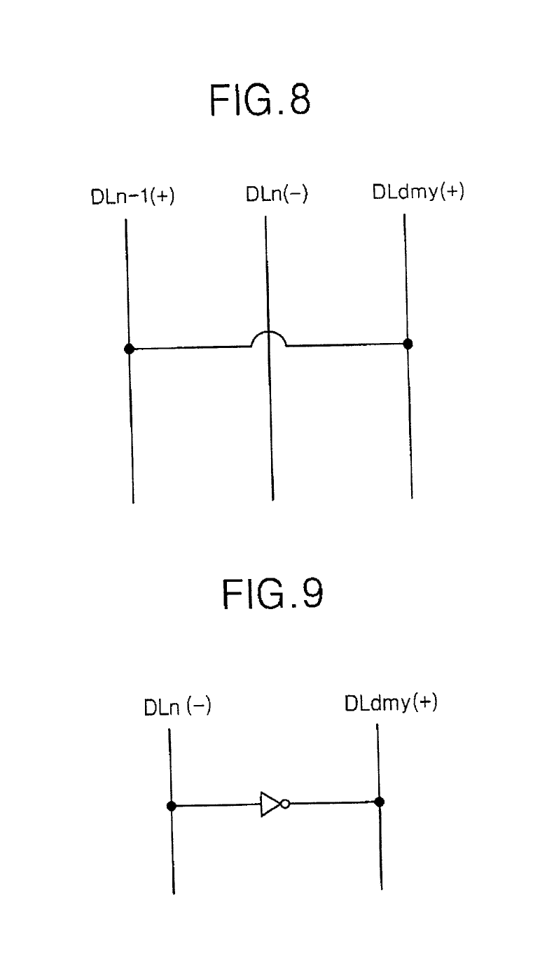

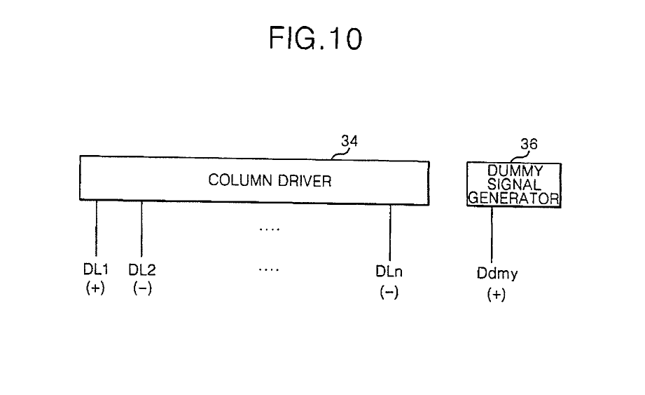

A signal phase-inverted with respect to the nth data line DLn is applied to the dummy data line DLdmy of the liquid crystal display panel 14 driven by such a dot-inversion system. To this end, a signal at the (n−1)^{th} data line DL(n−1) is applied to the dummy data line DLdmy with the aid of a shorting bar or a shorting line as shown in FIG. 8. Alternately, an inverter is installed between the nth data line DLn and the dummy data line DLdmy as shown in FIG. 9 to apply a signal having an inverted phase with respect to the nth data line DLn to the dummy data line DLdmy. Moreover, as shown in FIG. 10, the first to n^{th} data lines DL1 to DLn are formed via a column driver, and a signal having an inverted phase with respect to the nth data line DLn is formed at the dummy data line DLdmy with the aid of an additional dummy signal generator 36.

As described above, according to the present invention, the dummy data line is provided at the black matrix area of the outermost liquid crystal cell of the liquid crystal display panel, so that an electric charge amount accumulated in that area becomes equal to an electric charge amount accumulated in the liquid crystal cells at other areas. Accordingly, this electric charge amount generates the same coupling effect as the liquid crystal cell at other areas, to thereby prevent a brightening phenomenon of the liquid crystal cell connected to the last data line. Furthermore, according to the present invention, a position of the last data line can be adjusted depending on its brightening level to control the brightness of the liquid crystal cell.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A liquid crystal display (LCD) panel, comprising:
a plurality of data lines included in a display area of the LCD panel;
a plurality of gate lines crossing the data lines;
a dummy data line included in a non-display area outside the display area and formed in parallel to the data lines;
a plurality of switching devices positioned at intersections between the data lines and the gate lines; and
a plurality of pixel electrodes each driven by one of the switching devices.

2. The liquid crystal display panel as claimed in claim 1, wherein the dummy data line is supplied with a signal having an inverted phase with respect to data on a one of the data lines adjacent to the dummy data line.

3. The liquid crystal display panel as claimed in claim 1, further comprising:
a plurality of dummy switching devices positioned intersections between the dummy data line and the gate lines; and
a plurality of dummy pixel electrodes each connected to one of the dummy switching devices.

4. The liquid crystal display panel as claimed in claim 3, wherein the dummy data line and the dummy pixel electrodes each further include a black matrix for blocking light.

5. The liquid crystal display panel as claimed in claim 2, further comprising:
dummy voltage supply means for supplying the signal to the dummy data line.

6. The liquid crystal display panel as claimed in claim 5, wherein the dummy voltage supply means includes an inverter for performing a phase inversion of a signal on a data line adjacent to the dummy data line.

7. The liquid crystal display panel as claimed in claim 5, wherein the dummy voltage supply means includes a shorting bar for electrically connecting the dummy data line to the data line supplied with a voltage having the same phase as a voltage applied to the dummy data line.

8. The liquid crystal display panel as claimed in claim 5, wherein the dummy voltage supply means includes a dummy voltage generator for directly applying a voltage to the dummy data line.

9. A liquid crystal display (LCD) panel, comprising:
a plurality of data lines included in a display area of the LCD panel;
a plurality of gate lines crossing the data lines;
a plurality of switching devices positioned at intersections between the data lines and the gate lines;
a plurality of pixel electrodes each supplied with a voltage on the data line by a switching of the switching device; and
a dummy data line for compensating a capacitor value difference of an adjacent pixel electrode thereto.

10. The liquid crystal display panel as claimed in claim 9, wherein the dummy data line is supplied with a signal having an inverted phase with respect to data on a data line adjacent to the dummy data line.

11. The liquid crystal display panel as claimed in claim 9, further comprising:
a plurality of dummy switching devices positioned at intersections between the dummy data line and the gate lines; and
a plurality of dummy pixel electrodes each connected to one of the dummy switching devices.

12. The liquid crystal display panel as claimed in claim 9, wherein the dummy data line and the dummy pixel electrode each further includes a black matrix for blocking light.

13. The liquid crystal display panel as claimed in claim 10, further comprising: dummy voltage supply means for supplying the signal to the dummy data line.

14. The liquid crystal display panel as claimed in claim 13, wherein the dummy voltage supply means includes an inverter for performing a phase inversion of a signal on a data line adjacent to the dummy data line.

15. The liquid crystal display panel as claimed in claim 13, wherein the dummy voltage supply means includes a shorting line for electrically connecting the dummy data line to the data line supplied with a voltage having the same phase as a voltage applied to the dummy data line.

16. The liquid crystal display panel as claimed in claim 13, wherein the dummy voltage supply means includes a dummy voltage generator for directly applying a voltage to the dummy data line.

17. A method of driving a liquid crystal display panel, comprising the step of:
supplying video signals to pixel electrodes in a display area;
supplying a signal to the dummy data line in a non-display area for compensating a capacitor value difference of adjacent pixel electrodes thereto.

18. The method as claimed in claim 17, wherein the dummy data line is supplied with a signal having an inverted phase with respect to data on the data line being adjacent to the dummy data line.

19. A liquid crystal display (LCD) device, comprising:
a scanning line extending in a first direction;
a plurality of data lines extending in a second direction generally perpendicular to the scanning lines, such that the data lines cross the scanning lines;
a plurality of switching devices positioned where the data lines cross the scanning line, each switching device being connected with the scanning lines and one of the data lines;
a plurality of pixel electrodes each connected to one of the switching devices; and
a dummy data line formed in parallel to the data lines.

20. The LCD device of claim 19, further comprising:
dummy voltage supply means for supplying a signal such that a first voltage charged into a first one of the pixel electrodes which is adjacent to the dummy voltage line becomes approximately the same as a second voltage charged into a second one of the pixel electrodes disposed adjacent to the first one of the pixel electrodes.

21. The LCD device as claimed in claim 20, wherein the dummy voltage supply means comprises an inverter for inverting a signal on a data line adjacent to the dummy data line and supplying the inverted signal to the dummy data line.

22. The LCD device as claimed in claim 20, wherein the dummy voltage supply means includes a shorting bar for electrically connecting the dummy data line to one of the data lines which is not adjacent to the dummy data line.

23. The LCD device as claimed in claim 23, further comprising a column driver for supplying data voltages to the data lines.

24. The LCD device as claimed in claim 23, wherein the dummy voltage supply means includes a dummy voltage generator for directly applying a voltage to the dummy data line.

25. The LCD device of claim 20, wherein adjacent data lines have data signals with opposite polarities during a period when the scanning line supplies a scanning signal to the switching devices.
